(19) United States
(12) Patent Application Publication
(10) Pub. No.: US 2005/0092689 A1
(43) Pub. Date: May 5, 2005

(54) Modifier for polyelectrolytic flocculants

(76) Inventors: Tatiana Shevchenko, Kemerovo (RU); Elena Amelenko, Richmond Hill (CA)

Correspondence Address: KILYK & BOWERSOX, P.L.L.C., 53 A EAST LEE STREET, WARRENTON, VA, 20186, US

(21) Appl. No.: 10/701,393

(22) Filed: Nov. 4, 2003

(51) Int. Cl. C02F 1/52; C02F 1/54

(52) U.S. Cl. 210/729

(57) ABSTRACT

There is provided purification techniques applicable to the aqueous suspensions in order to remove the suspended particles. The present invention deals with purification of aqueous suspension having essentially different nature and solid phase content in particular with purification of technological stream of the aqueous suspensions formed in chemical, coalmining, oil, ore, pulp and paper industries and others. The flocculant applied is treated by a mixture of surfactants: ethylene glycol monoalkyl ether or propylene glycol monoalkyl ether or propylene glycol and halogen hydrides of ethylene or halogen hydrides of propylene, olefin oxide or mixtures thereof. Intensification effect is created due to increasing flocculant molecular mass.

### FIELD OF THE INVENTION

The present invention relates to a modifier for enhancing the properties of polyelectrolytic flocculants used for the treatment of aqueous slurries. The modifier composition can be used in flocculating processes to prepare water for drinking, as well as for the treatment/purification of aqueous slurries formed in chemical, coalmining, oil, ore, pulp and paper industries and others.

### BACKGROUND OF THE INVENTION

Polyelectrolytic flocculants are widely used in industry to cause solids in aqueous slurries to precipitate out and separate from the aqueous component of the slurry as a result of agglomerates formation. The speed of precipitation, degree of sedimentation (degree of transparency) and consumption of the flocculant all depend on the molecular mass and type of flocculant used.

Polyacrylamide has been a widely used polyelectrolytic flocculent. The main drawback with using polyacrylamide is its low purification efficiency when treating industrial slurries and natural waters, that is, the speed of precipitation is slow and the degree of purification not high.

There have been attempts in the prior art to try to enhance the flocculating properties of polyelectrolytic flocculants, in particular polyacrylamide-type flocculants. For example, U.S. Pat. No. 4,125,508 to Elfers discloses a flocculant composition and a method of making that composition. The composition is made using four steps as follows:
1. polymerizing monomers, including acrylamide;
2. removing any remaining water from the polymerization step;
3. adding a suitable glycol or glycol ether, including diethylene glycol diethyl ether or ethylene glycol monomethyl ether; and
4. removing any hydrocarbon solvent.

This composition comprises polyacrylamide and a monoalkyl ether of ethylene glycol and can be used in a flocculating process.

U.S. Pat. No. 4,210,531 to Wang discloses a process for de-watering a mineral concentrate using polyacrylamide. The process disclosed in the Wang Patent includes the following steps:
1. mixing in the slurry an effective amount of a flocculant, preferably polyacrylamide; and
2. mixing an effective amount of an anionic surface active agent and a water-insoluble organic liquid.

U.S. Pat. No. 4,565,635 to Le Du also teaches a method of flocculation. The method includes the addition of a “flocculating adjuvant” to the flocculating agent, in which the adjuvant is a water-soluble biogum heteropolysaccharide.

U.S. Pat. No. 4,820,450 to Wile teaches the use of a polyacrylamide flocculant in a detergent solution to help precipitate and quickly settle to the bottom any solids present in the aqueous solution. The Wile Patent teaches that the addition of polyacrylamide enhances the effect of the detergents. Some of the examples provided in the Wile Patent disclose compositions that include polyacrylamide and a monoalkyl ether of ethylene glycol.

U.S. Pat. No. 5,990,216 to Cai discloses a new polyacrylamide flocculant, in which the polyacrylamide is co-polymerized with starch or cellulose. The Cai Patent does mention that additives may be included with the polyacrylamide flocculant.

U.S. Pat. No. 6,485,651 to Branning discloses a method of quickly dispersing a flocculant in an aqueous slurry. The Branning Patent teaches that the flocculant composition is a water-in-oil emulsion that includes a flocculant and at least one hydrophilic surfactant. The flocculant may be polyacrylamide.

U.S. patent application Ser. No. 2002/0137858 discloses a polyacrylamide that provides improved flocculating. The polyacrylamide is prepared by polymerization of suitable monomers in the presence of a specific chain branching agent. There is no teaching in this patent application of combining the polyacrylamide with other additives to enhance the performance of the flocculant.

U.S. patent application Ser. No. 2002/0190005 appears to be related to the Branning Patent discussed above. It teaches the use of a water-in-oil emulsion containing polyacrylamide and a hydrophilic surfactant.

There, therefore, remains a need to provide an additive or modifier that can be used with a polyelectrolytic flocculent, particularly polyacrylamide, to enhance its performance as a flocculant.

The disclosures of all patents/applications referenced herein are incorporated herein by reference.

### SUMMARY OF THE INVENTION

According to a first aspect of the present invention, there is provided a modifier for enhancing the flocculating properties of a polyelectrolytic flocculant, preferably a polyacrylamide-type flocculant, comprising:
a. an effective amount of a surfactant, preferably a monoalkyl ether of ethylene glycol selected from the group consisting of ethylene glycol monoalkyl ether, propylene glycol monoalkyl ether, propylene glycol and mixtures thereof; and
b. an effective amount of halogen hydrides of ethylene or halogen hydrides of propylene, or olefin oxide or mixtures thereof,

wherein the modifier is added to the polyelectrolytic flocculant prior to the use of the polyelectrolytic flocculent in a flocculating process.

In a further aspect, a flocculation process is provided for treating an aqueous slurry, the process comprising the steps of:
a. providing a modifier comprising:
   i. an effective amount of a surfactant, preferably a monoalkyl ether of ethylene glycol selected from the group consisting of ethylene glycol monoalkyl ether, propylene glycol monoalkyl ether, propylene glycol and mixtures thereof; and
   ii. an effective amount of halogen hydrides of ethylene or halogen hydrides of propylene, or olefin oxide or mixtures thereof;
b. mixing a flocculating-enhancing amount of the modifier with a polyelectrolytic flocculant, preferably a polyacrylamide-type flocculent, to form a flocculating composition;
c. treating the aqueous slurry with the flocculating composition to cause solid flocks to precipitate from the slurry.

In yet a further aspect of the present invention, there is provided a flocculation process for treating an aqueous slurry, the process comprising the steps of:
a. providing a flocculating composition comprising:
   i. an effective amount of a polyelectrolytic flocculant, preferably a polyacrylamide-type flocculant; and
   ii. an effective amount of a modifier, wherein the modifier comprises:
      A. an effective amount of a surfactant, preferably a monoalkyl ether of ethylene glycol selected from the group consisting of ethylene glycol monoalkyl ether, propylene glycol monoalkyl ether, propylene glycol and mixtures thereof; and
      B. an effective amount of halogen hydrides of ethylene or halogen hydrides of propylene, or olefin oxide or mixtures thereof; and
b. treating the aqueous slurry with the flocculating composition to cause solid flocks to precipitate from the slurry.

Numerous other objectives, advantages and features of the present invention will also become apparent to the person skilled in the art upon reading the detailed description of the preferred embodiments, the examples and the claims.

### DETAILED DESCRIPTION OF THE PREFERRED EMBODIMENTS

In one of its preferred embodiments, the present invention provides a composition for use as a flocculant comprising an effective amount of a polyelectrolytic flocculant, preferably a polyacrylamide-type flocculant; an effective amount of a surfactant, preferably a monoalkyl ether of ethylene glycol selected from the group consisting of ethylene glycol monoalkyl ether, propylene glycol monoalkyl ether, propylene glycol and mixtures thereof; and an effective amount of halogen hydrides of ethylene or halogen hydrides of propylene, or olefin oxide or mixtures thereof. The flocculating composition is used in a typical flocculating process to prepare water for drinking, as well as for the treatment/purification of aqueous slurries formed in chemical, coalmining, oil, ore, pulp and paper industries and others.

As described above, it is known in the art to use a polyacrylamide as the polyelectrolytic flocculant. The performance of a polyelectrolytic flocculant such as polyacrylamide alone as a flocculant, however, is not as efficient as desirable. Polyelectrolytic flocculants are expensive, thus it would be desirable to reduce the quantity required. A relatively large amount of a polyelectrolytic flocculant is needed for a given amount of flocculation, and the time required to complete the flocculation process is relatively long. It has been found by the inventors herein that the addition to the polyelectrolytic flocculant of a modifier being a mixture of surfactants and halogen hydrides of ethylene or propylene, olefin oxide or mixtures thereof enhances the molecular mass of the flocculant. This in turn enhances the performance of the polyelectrolytic flocculant as a flocculant. This is advantageous, as less polyelectrolytic flocculant will be needed in a given flocculating process, and the flocks formed are larger and more easily separated. Moreover, it has been found that the time required to carry out the process is reduced; in other words, the use of the composition of the present invention increases the efficiency of the flocculation process.

A further aspect of the present invention is the provision of a “modifier”, being a mixture of surfactants and halogen hydrides of ethylene, propylene or olefin oxide. This modifier can then be added to the polyelectrolytic flocculant prior to its use in a flocculating process.

Thus, prior to its use in a flocculation process, the polyelectrolytic flocculant is modified by the modifier being a mixture of surfactants such as ethylene glycol monoalkyl ether or propylene glycol monoalkyl ether or propylene glycol, and halogen hydrides of ethylene, halogen hydrides of propylene, olefin oxide or mixtures thereof. This modifier is believed to cause the molecular mass of the polyelectrolytic flocculant, in particular polyacrylamide, to increase due to molecular agglomeration of the modifier with the polyelectrolytic flocculant. The increased molecular mass increases the efficiency of the flocculation process: the process becomes faster due to the larger-sized flocks formed; sediment density is increased; and the degree of purification (degree of transparency of the liquid) also increases.

The present invention may be used to modify any polyelectrolytic-type flocculant. A preferred polyelectrolytic flocculent is a polyacrylamide available under the trademark MAGNAFLOC® from Ciba Speciality Chemicals, Bradford, West Yorkshire, Switzerland. Ciba Speciality Chemicals currently offers a range of MAGNAFLOC® polyacrylamide flocculants including MAGNAFLOC® 3230, MAGNAFLOC® 4240, MAGNAFLOC® 5250, and MAGNAFLOC® 6260.

In the modifier composition of the present invention, one or more surfactants are used. Preferably, the surfactant is a mixture of propylene glycol, ethylene glycol monoalkyl ether with the general formula:
R—O—CH₂—CH₂—OH (I)

or propylene glycol monoalkyl ether with the general formula:
R—O—CH(OH)—CH₃ (II)

where R is a hydrocarbon radical of the form CₙH₂ₙ₊₁, where n is an integer from 1 to 10.

The preferred halogen hydrides of ethylene are those having the general form:
H₂C—CH₂—X (IV)

and the preferred halogen hydrides of propylene are those having the general form:
CH₃—CH(OH)—CH₂—X (V)

where X is a halogen selected from the group consisting of chlorine, bromide and iodine.

In the modifier composition, the mass ratio of surfactant to halogen hydrides of ethylene, propylene, olefin oxide or mixtures thereof is preferably in the range of from about 1:100 to about 100:1, more preferably in the range of from about 1:50 to about 50:1, and most preferably in the range of from about 1:10 to about 10:1.

In a preferred embodiment of the present invention, the flocculating composition comprises from about 40 wt % to about 97 wt % of the polyelectrolytic flocculent, and from about 3 wt % to about 60 wt % of the modifier composition. More preferably, the flocculating composition comprises from about 70 wt % to about 97 wt % of the polyelectrolytic flocculent, and from about 3 wt % to about 30 wt % of the modifier composition, and most preferably the flocculating composition comprises from about 80 wt % to about 97 wt % of the polyelectrolytic flocculent, and from about 3 wt % to about 20 wt % of the modifier composition. The amount of modifier in the flocculating composition depends on the degree of ionization of the polyelectrolytic flocculent; the more the flocculant's degree of ionization, the more modifier will be needed in the composition.

The following examples illustrate the various advantages of the preferred method of the present invention.

### EXAMPLES

### Example 1

0.40 dm³ of an aqueous slurry containing suspensions of waste was obtained from coal preparation. The solid phase content was measured as 160 g/dm³. 5.6 ml of a 0.03% anionic flocculant (with medium degree of ionization) solution of polyacrylamide-type flocculant was added to the aqueous slurry. The entire aqueous slurry was mixed by turning over the measuring cylinder five times, after which the time required for sedimentation of most of the solid phase flocks was recorded. This sedimentation time was measured as 280 seconds.

### Examples 2-5

Examples 2-5 were carried out according to the procedure described in Example 1 and using the same aqueous slurry quantities. In examples 2-5, the anionic flocculent solution of polyacrylamide-type flocculant was first treated with a modifier composition. Different amounts of modifier (3-6 wt % of flocculant mass) were used for treating the polyacrylamide-type flocculant. The sedimentation time was recorded, as well as the transparency or clarity of the resulting solution. The results obtained are summarized in Table 1.

TABLE 1

| | Amount of | | | |
|---|---|---|---|---|
| | Modifier | | Flocculant | |
| Ex- | Used in | Sedimen- | Solution | Degree of |
| ample | Polyacrylamide, | tation | Consumption, | Transparency, |
| # | wt % | Time, sec | ml. | % |
| 1 | 0 | 280 | 5.60 | 96.1 |
| 2 | 3 | 265 | 1.80 | 97.0 |
| 3 | 4 | 259 | 1.55 | 98.0 |
| 4 | 5 | 258 | 1.50 | 98.2 |
| 5 | 6 | 260 | 1.60 | 98.5 |

The results in Table 1 show a number of things. First, flocculant consumption is up to 3.7 times lower as more modifier is added to the polyacrylamide-type flocculent. Second, sedimation time is also reduced, and the degree of transparency of the resulting solution increases by 2.4%.

### Examples 6-8

Three samples of river water were obtained, each having varying amounts of initial solid content. Each sample was further divided into two sub-samples and each sub-sample treated with a polyacrylamide-type flocculant only and a polyacrylamide-type flocculant treated with the modifier. The same procedure as described in Examples 1-5 was carried out. The experimental results are summed up in Table 2.

TABLE 2

| | | Sedimentation time, | | Flocculant dose, | | Degree of | |
|---|---|---|---|---|---|---|---|
| | Solid | sec | | mg/dm³ | | transparency, % | |
| | phase | No | | No | | No | |
| | content, | Modifier | Modifier | Modifier | Modifier | Modifier | Modifier |
| Example # | mg/dm³ | Added | Added | Added | Added | Added | Added |
| 6 | 35 | 700 | 600 | 0.5 | 0.05 | 97.5 | 99.5 |
| 7 | 46 | 600 | 490 | 0.4 | 0.03 | 97.2 | 99.4 |
| 8 | 74 | 520 | 405 | 0.8 | 0.07 | 97.0 | 99.4 |

Table 2 shows that flocculant consumption is 13 times lower when the modifier is added as compared to using a polyacrylamide-type flocculant only. Furthermore, sedimentation time is reduced and the degree of transparency increases by 2-2.4%.

The results presented in Tables 1 and 2 show that the aqueous suspension purification method of the present invention decreases the time of suspension clarification by 8-28%, increases the process efficiency due to decreasing consumption of the expensive polyacrylamide-type flocculant by 3.7-13 times; and increases the degree of transparency of the resulting liquid phase by 2-2.4%.

### Examples 9-14

A coal aqueous suspension having a volume of 0.40 dm³ and an initial solid phase content of 200 g/dm³ was used in these examples. In example 9, 7 ml of a 0.03% solution of a polyacrylamide-type flocculent (with high degree of ionization) was added to the coal aqueous suspension. The sedimentation time was measured to be 300 seconds.

Examples 10-14 were carried out using the same the procedure as for Example 9. The polyacrylamide-type flocculant was first treated with varying amounts of the modifier composition. The results obtained are summarized in Table 3.

TABLE 3

| | Amount of | | | |
|---|---|---|---|---|
| | Modifier | | Flocculant | |
| Ex- | Used in | Sedimen- | solution | Degree of |
| ample | Polyacrylamide, | tation | consumption, | transparency, |
| # | wt % | Time, sec | ml | % |
| 9 | 0 | 300 | 7.0 | 96.5 |
| 10 | 5 | 295 | 6.80 | 96.9 |
| 11 | 25 | 280 | 5.00 | 97.6 |
| 12 | 40 | 270 | 3.50 | 98.4 |
| 13 | 50 | 260 | 1.70 | 99.4 |
| 14 | 60 | 259 | 1.68 | 99.5 |

The results of Table 3 show that flocculant consumption is reduced up to 4 times lower compared to using a polyacrylamide-type flocculant only. As well, sedimentation time decreases by 13.7% and the degree of transparency increases by 2-3%.

Although the present invention has been shown and described with respect to its preferred embodiments and in the examples, it will be understood by those skilled in the art that other changes, modifications, additions and omissions may be made without departing from the substance and the scope of the present invention as defined by the attached claims.

1. A modifier for enhancing the flocculating properties of a polyelectrolytic flocculant, preferably a polyacrylamide-type flocculant, comprising:
(a) an effective amount of a surfactant, preferably a monoalkyl ether of ethylene glycol selected from the group consisting of ethylene glycol monoalkyl ether, propylene glycol monoalkyl ether, propylene glycol and mixtures thereof; and
(b) an effective amount of halogen hydrides of ethylene, halogen hydrides of propylene, olefin oxide or mixtures thereof,
wherein the modifier is added to the polyelectrolytic flocculant prior to the use of the polyelectrolytic flocculant in a flocculating process.

2. The modifier of claim 1, wherein the mass ratio of surfactant to halogen hydrides of ethylene or halogen hydrides of propylene, olefin oxide or mixtures thereof is in the range of from about 1:100 to about 100:1, more preferably in the range of from about 1:50 to about 50:1, and most preferably in the range of from about 1:10 to about 10:1.

3. A composition for use in a flocculation process, comprising:
(a) an effective amount of a polyelectrolytic flocculant, preferably a polyacrylamide-type flocculant; and
(b) an effective amount of a modifier, wherein the modifier comprises:
i) an effective amount of a surfactant, preferably a monoalkyl ether of ethylene glycol selected from the group consisting of ethylene glycol monoalkyl ether, propylene glycol monoalkyl ether, propylene glycol and mixtures thereof; and
ii) an effective amount of halogen hydrides of ethylene or halogen hydrides of propylene, olefin oxide or mixtures thereof.

4. The composition of claim 3, wherein in the modifier the mass ratio of surfactant to halogen hydrides of ethylene or halogen hydrides of propylene, olefin oxide or mixtures thereof is in the range of from about 1:100 to about 100:1, more preferably in the range of from about 1:50 to about 50:1, and most preferably in the range of from about 1:10 to about 10:1.

5. The composition of claim 3, comprising:
(a) from about 40 wt % to about 97 wt %, more preferably from about 70 wt % to about 97 wt %, and most preferably from about 80 wt % to about 97 wt % of the polyelectrolytic flocculant, and
(b) from about 3 wt % to about 60 wt %, more preferably from about 3 wt % to about 30 wt %, and most preferably from about 3 wt % to about 20 wt %, of the modifier.

6. A flocculation process for treating a an aqueous slurry, the process comprising the steps of:
(a) providing a modifier comprising:
i) an effective amount of a surfactant, preferably a monoalkyl ether of ethylene glycol selected from the group consisting of ethylene glycol monoalkyl ether, propylene glycol monoalkyl ether, propylene glycol and mixtures thereof; and
ii) an effective amount of halogen hydrides of ethylene or halogen hydrides of propylene, olefin oxide or mixtures thereof;
(b) mixing a flocculating-enhancing amount of the modifier with a polyelectrolytic flocculant, preferably a polyacrylamide-type flocculant, to form a flocculating composition;
(c) treating the aqueous slurry with the flocculating composition to cause solid flocks to precipitate from the slurry.

7. The process of claim 6, wherein in the modifier the mass ratio of surfactant to halogen hydrides of ethylene or halogen hydrides of propylene, olefin oxide or mixtures thereof is in the range of from about 1:100 to about 100:1, more preferably in the range of from about 1:50 to about 50:1, and most preferably in the range of from about 1:10 to about 10:1.

8. The process of claim 6, wherein from about 3 wt % to about 60 wt %, more preferably from about 3 wt % to about 30 wt %, and most preferably from about 3 wt % to about 20 wt %, of the modifier is mixed with from about 40 wt % to about 97 wt %, more preferably from about 70 wt % to about 97 wt %, and most preferably from about 80 wt % to about 97 wt % of the polyelectrolytic flocculant.

9. A flocculation process for treating a an aqueous slurry, the process comprising the steps of:
(a) providing a flocculating composition comprising:
i) an effective amount of a polyelectrolytic flocculant, preferably a polyacrylamide-type flocculant; and
ii) an effective amount of a modifier, wherein the modifier comprises:
A) an effective amount of a surfactant, preferably a monoalkyl ether of ethylene glycol selected from the group consisting of ethylene glycol monoalkyl ether, propylene glycol monoalkyl ether, propylene glycol and mixtures thereof; and
B) an effective amount of halogen hydrides of ethylene or halogen hydrides of propylene, olefin oxide or mixtures thereof.
(b) treating the aqueous slurry with the flocculating composition to cause solid flocks to precipitate from the slurry.

10. The process of claim 9, wherein in the modifier the mass ratio of surfactant to halogen hydrides of ethylene or halogen hydrides of propylene, olefin oxide or mixtures thereof is in the range of from about 1:100 to about 100:1, more preferably in the range of from about 1:50 to about 50:1, and most preferably in the range of from about 1:10 to about 10:1.

11. The process of claim 9, wherein from about 3 wt % to about 60 wt %, more preferably from about 3 wt % to about 30 wt %, and most preferably from about 3 wt % to about 20 wt %, of the modifier is mixed with from about 40 wt % to about 97 wt %, more preferably from about 70 wt % to about 97 wt %, and most preferably from about 80 wt % to about 97 wt % of the polyelectrolytic flocculant.

12. The composition of claim 4, comprising:
(a) from about 40 wt % to about 97 wt %, more preferably from about 70 wt % to about 97 wt %, and most preferably from about 80 wt % to about 97 wt % of the polyelectrolytic flocculant, and
(b) from about 3 wt % to about 60 wt %, more preferably from about 3 wt % to about 30 wt %, and most preferably from about 3 wt % to about 20 wt %, of the modifier.

13. The process of claim 7, wherein from about 3 wt % to about 60 wt %, more preferably from about 3 wt % to about 30 wt %, and most preferably from about 3 wt % to about 20 wt %, of the modifier is mixed with from about 40 wt % to about 97 wt %, more preferably from about 70 wt % to about 97 wt %, and most preferably from about 80 wt % to about 97 wt % of the polyelectrolytic flocculant.

14. The process of claim 10, wherein from about 3 wt % to about 60 wt %, more preferably from about 3 wt % to about 30 wt %, and most preferably from about 3 wt % to about 20 wt %, of the modifier is mixed with from about 40 wt % to about 97 wt %, more preferably from about 70 wt % to about 97 wt %, and most preferably from about 80 wt % to about 97 wt % of the polyelectrolytic flocculent.
